(19) United States
(12) Patent Application Publication
(10) Pub. No.: US 2011/0263364 A1
(43) Pub. Date: Oct. 27, 2011

(54) Infinitely Variable Transmission

(76) Inventor: Mark William Klarer, (US)

(21) Appl. No.: 12/767,782

(22) Filed: Apr. 26, 2010

(51) Int. Cl. F16H 61/662; F16H 9/24

(52) U.S. Cl. 474/70; 474/69

(57) ABSTRACT

A step less, infinitely variable transmission converting rotational input power to rotational output power using positively engaged mechanics without relying on friction to transmit power and having minimal intermittent motion. The transmission includes a plurality of input chains with drive pins and a rotatable output chain with engagement slots meshing with input pins. The input chains have a plurality of horizontal tracks that control the pins' horizontal position. Precise pin horizontal positions are controlled by another track—a synchronizing track. The synchronizing track is controlled by any combination of high speed electronics, computers, linear actuators, and servo motors. In another embodiment, mechanical gears and mechanical calculators can govern the synchronizing tracks. The constant need to synchronize elements with intermittent motion, and not relying on friction to transmit power place the transmission most closely with the ratcheting type of continuously variable transmissions, despite the use of ratchets.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND-FIELD

This application relates to mechanical transmissions, specifically to infinitely variable transmissions.

### BACKGROUND-PRIOR ART

A mechanical transmission device is needed to select optimal mechanical advantage and gear reduction between a rotary input power, such as a motor, to an output power application, such as a wheel. Power developing devices have optimal efficiency rotation speeds, maximum power speeds, and limited operating ranges for angular speed. This will differ greatly from applications, such as wheels forcing vehicles along ground. In order to accommodate a mechanical power device for optimum efficiency, speed range, torque and power requirements, the transmission is required to adjust gear ratios between the engine and mechanical load, such as a wheel.

Infinitely variable transmissions using friction to transmit power are typically useful in limited scope. Their applications are found in very few instances where any combinations of torque, power, and speed would not prohibit their use. The need for any of the following: high speed, torque or power would necessitate a positively engaged transmission, that is, a transmission that does not rely on friction to transmit power, with a predetermined small set of fixed gears. For example in earth moving equipment, the torque requirements are very high and would eliminate possibilities of using variable transmissions where power is transmitted through friction using belts and pulleys. An infinitely variable transmission with positive mechanical engagement that can operate at higher torque, speed and power compared with transmissions that use friction to transmit power would be highly desirable.

### SUMMARY

The invention provides a solution to the above requirements, by converting input rotary power to output rotary power with infinitely variable gear ratios that can deliver high speed, torque, and power. The input axle has a rotation sensor attached to allow an electronic or mechanical computer to determine the rotational position of the input axle. The rotational position of the input axle is required to determine exactly when resynchronization of the input chains is required. The input axle's power is split through a gear assembly to a plurality of axles that drive the input chains. A plurality of input assemblies is required in order to keep continuous power to the output, as the drive pins engage and disengage with the output chain engagement slots. The input chains power the drive pins. The drive pins have a degree of freedom with respect to the input chains, as they can slide horizontally with little friction in slots. The horizontal position of the drive pin is governed with a synchronizing track. The drive pins ride along the synchronizing track much like a roller coaster car on a track, with low friction movement using bearings. As the input chain advances the drive pins along the output chain slots, the synchronizing track forces the drive pins to move along a very precise straight line, along the path of the chain. The synchronizing track and the input chain work together to precisely position the drive pin. The synchronizing track's position is precisely controlled in one embodiment using a high speed robotics servo motor, capable of accurately and quickly positioning the track to the desired location to allow precision meshing with the output chain engagement slots. In another embodiment, the synchronizing position can be governed with a mechanical means that can perform analog computations such as multiplication, addition, etc.

The output chain has equally, closely, spaced engagement slots that the drive pins run through. The engagement slots attached to the output chain also ride in a track using low friction bearings in order to govern precise movement around the chain path. As the input chain advances, powered ultimately from the input axle, and driving the drive pin in a straight line, this motion will force an advancement of the output chain as the drive pin glides along the output chain engagement slot. The output chain can rotate. The plane of rotation (ie x-z plane) is the same as the plane for the input chains (ie x-z plane). The precise angle of rotation of the output chain is determined through mechanical means, in one embodiment, a highly precise servo (herein called the gear ratio servo) driven worm gear drives a rotatable housing, or parallelogram setup of levers, that house the output chain. The gear ratio servo's actions are determined preferably by computer control, to allow for human operator attention on operating the vehicle or machinery. However, more precise control can be acquired by the operator if needed.

The ratio of the speed from input chain to output chain depends on the angle of the output chain with respect to the input chain. For example when the output chain engagement slots are precisely parallel with the input chain motion, the effective gear reduction is infinite, as any movement from the drive pin will result in the output chain not moving. This would be equivalent to the ‘park’ gear on an automatic transmission. As the angle of the output chain is increased from 0 with respect to the input chain, the gear ratio from input to output will also increase, up until the maximum angle for the output chain is set.

The output chain's axle rotates with the output chain assembly. A mechanical means is necessary to connect the output chain's axle to a fixed axle. In one embodiment, the output axle is connected to a constant velocity joint, with bend center exactly in line with the output assembly's axis of rotation, with the other side of the constant velocity joint connected to an axle held rotatable. In another embodiment, the output chain's axle is connected with a series levers on pivots and either gears or gears and chains that will allow the output chain to rotate freely and also be connected to a fixed axle. Another embodiment uses a large planetary gear that rotates on the same plane as the output chain assembly, and the output chain's axle will drive the planetary gear through a system of gears and axles, with another fixed axle meshing with the planetary gear.

As with most all transmissions, this invention requires particular attention to accuracy of components fitting together and moving very accurately with no undesired degrees of freedom. Most all parts must move in a perfect line, circle, or track. Computer controlled servo motors must be fast, accurate, and in some circumstances power the output briefly. In addition, sensors such as rotation sensors must be precise enough and have the required response time to accurately report axle speed and rotation to the transmission computer.

The preferred embodiment makes use of an electronic transmission computer that can read sensor values, such as rotation sensors, and also control servo motors. The transmission computer described is capable of running a plurality of program threads, or loops, simultaneously, and is fast and accurate enough to perform mathematical operations to accurately control moving components. The servo motors described are robotics stepper motors, their capabilities include accurate axle positioning, speed control, and contain rotation sensors for internal position feedback. The robotics stepper motors have very flexible operation, including stepping tiny increments at a time, or free running at different speeds and directions.

Different sets of modes can be applied for each application. For example, in a passenger automobile, a mode such as economy can be employed, where gear ratios are purposely kept as high as possible without stalling an internal combustion engine. Another mode such as an invisible mode, where the engine is kept as quiet as possible and gear shifting rates are kept low can be applied. Another mode, high power mode, where higher engine rpms at idle and cruise are maintained in anticipation of quickly increasing engine speed to maximum power rpms can be applied. A standard mode should be applied as a default, that is an optimal blend of characteristics that would suit an average driver well. These are a few examples of many different modes that can be applied for an application. An operator of a machine containing this transmission can start the machine in a default mode, or the last mode applied when the machine was turned off. The user could also choose from a palette of different modes depending on circumstances or mood. An advanced operator could specify a blend of several different modes, or perhaps even tweak each parameter for a set of custom modes. These modes could be kept within the transmission computer and adjusted with a control panel, or specified and or controlled through another computer within the vehicle, such as a main computer vehicle or a user interface computer.

### DRAWINGS

### Figures

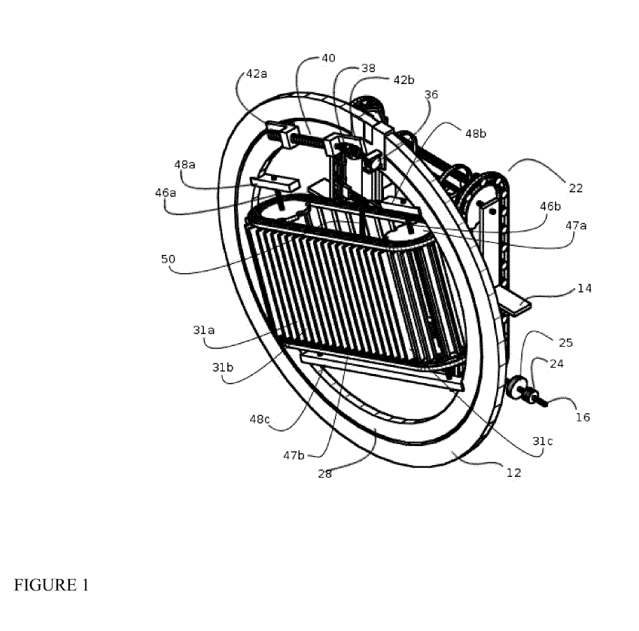

FIG. 1 is a ¾ perspective view of an embodiment of a continuously variable positively engaged transmission.

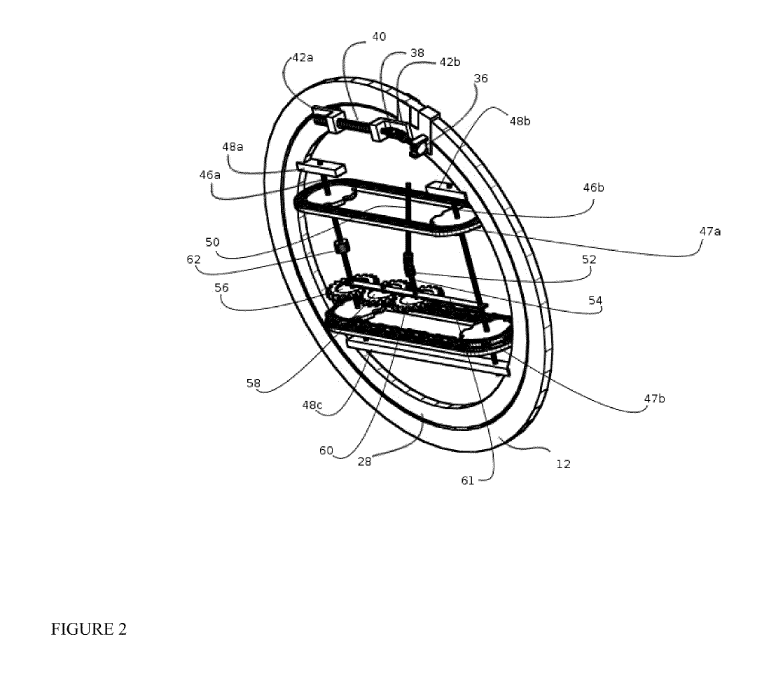

FIG. 2 is a ¾ view of the output assembly without the engagement slots to expose inner parts.

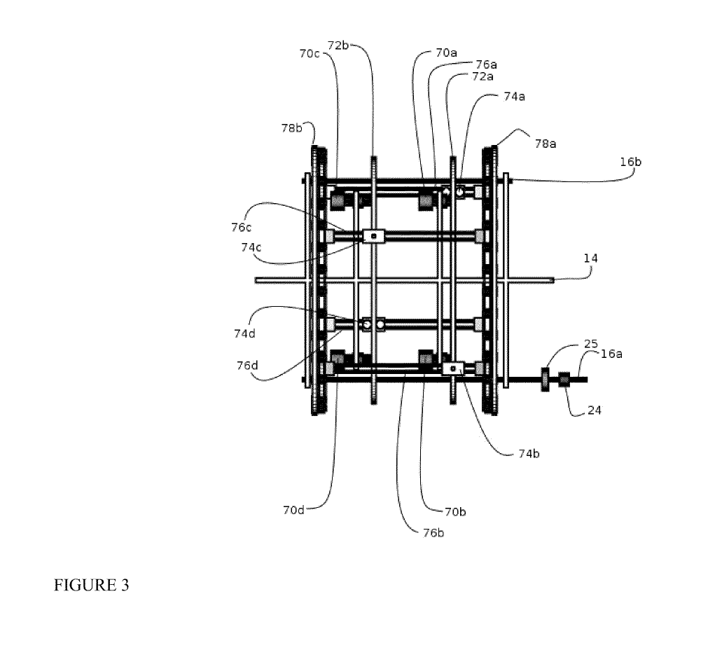

FIG. 3 is a front view of the input assembly.

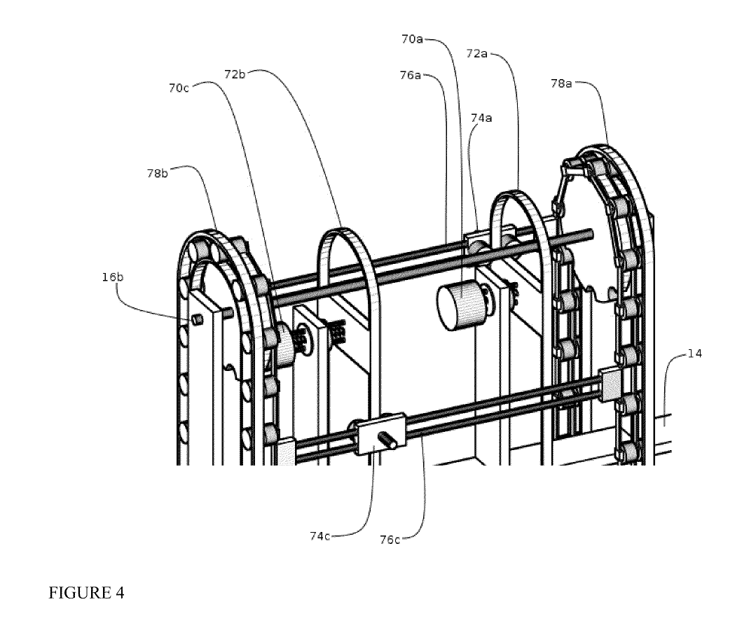

FIG. 4 is a ¾ perspective view of the detail of the input assembly.

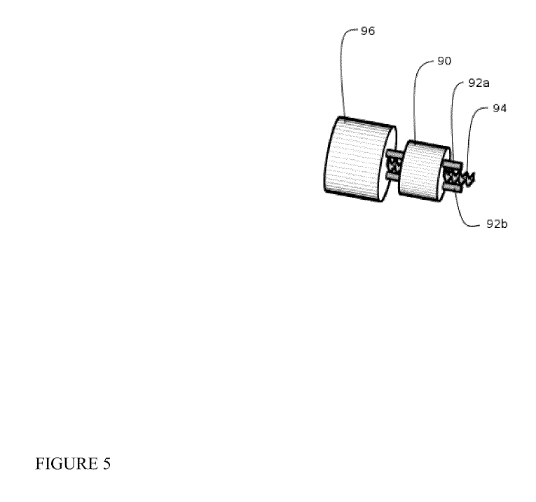

FIG. 5 is a detail of a servo assembly.

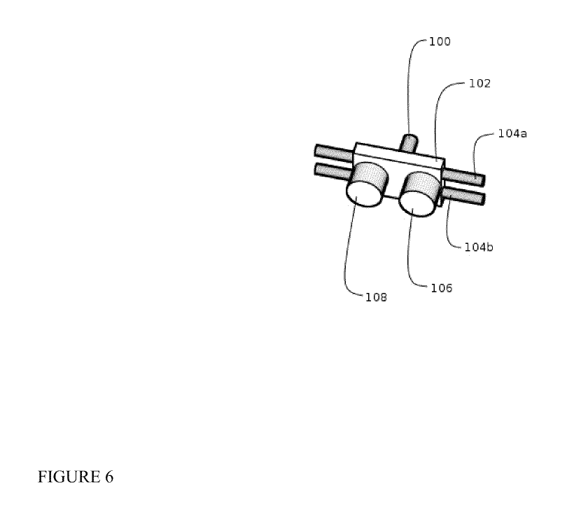

FIG. 6 is a detail of a pin assembly.

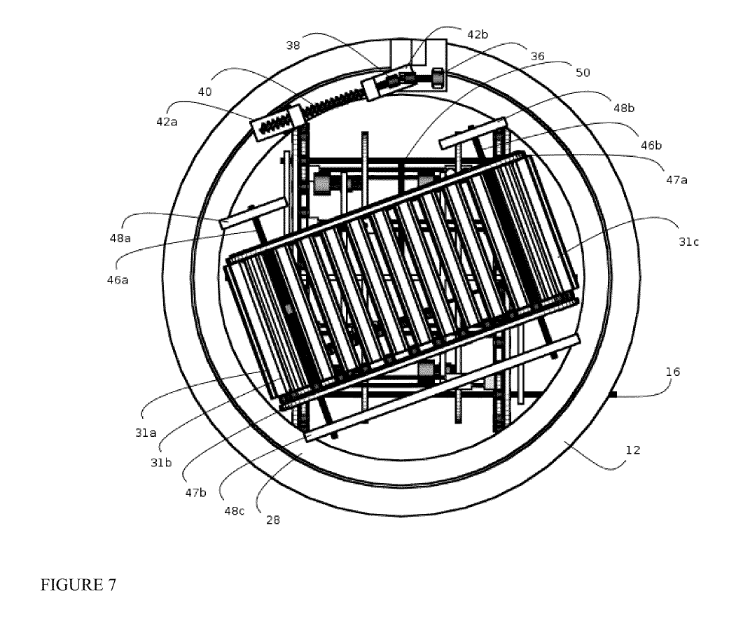

FIG. 7 is a front view showing the transmission in a forward gear.

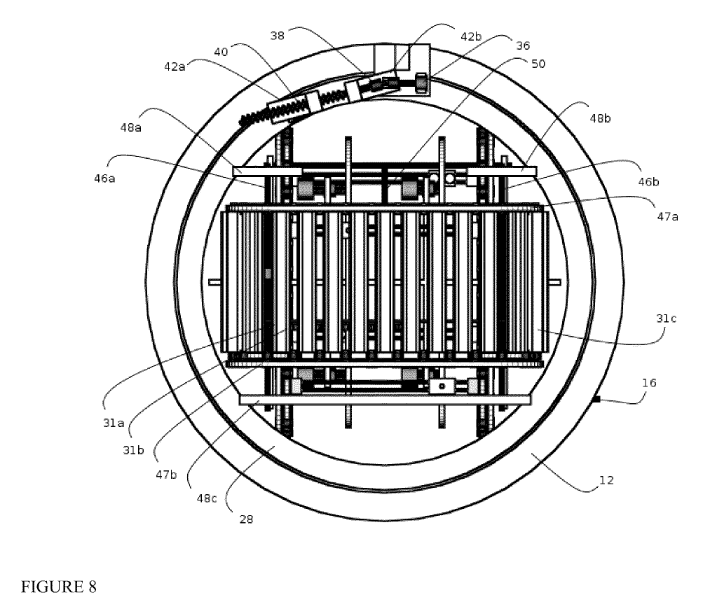

FIG. 8 is a front view showing the transmission in gear 0.

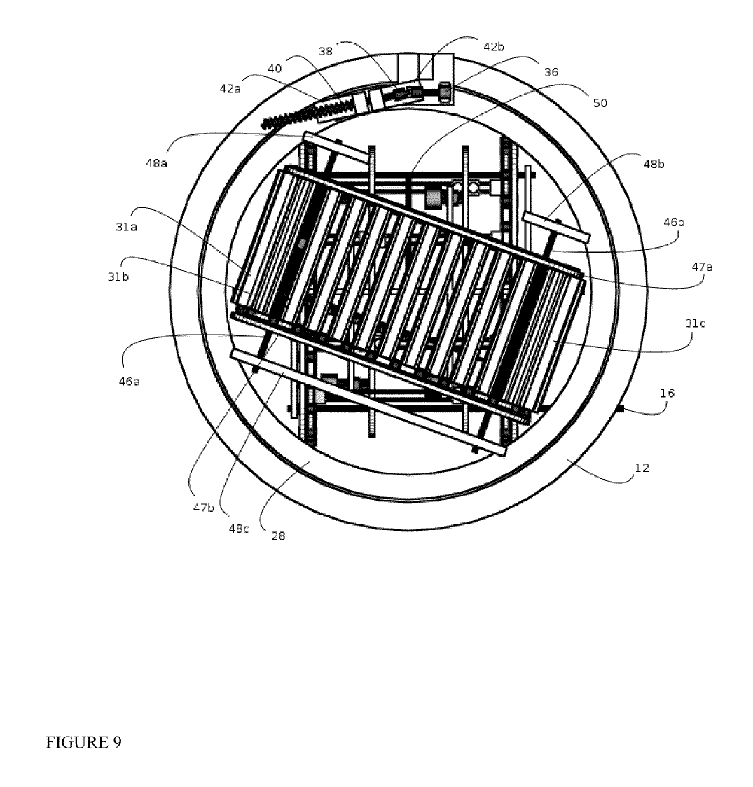

FIG. 9 is a front view showing the transmission in a reverse gear.

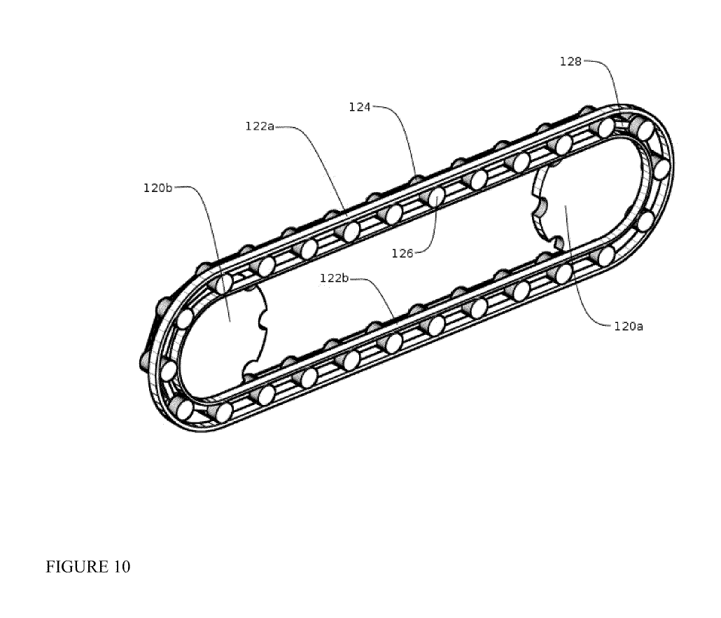

FIG. 10 is a detail of a chain assembly.

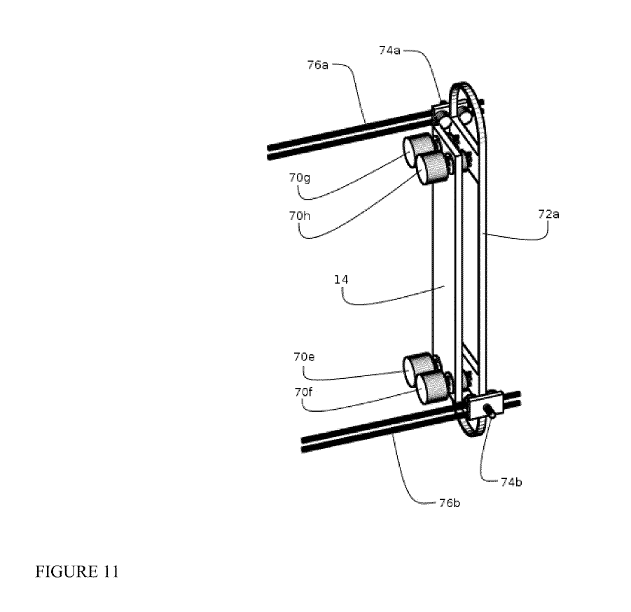

FIG. 11 is a detail of an embodiment showing 4 servo assemblies per track.

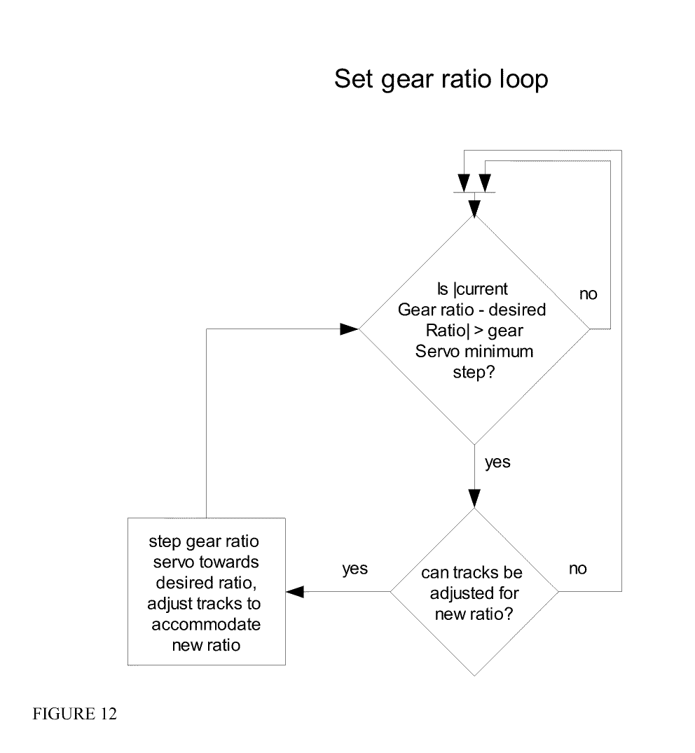

FIG. 12 is a flowchart for the transmission computer gear ratio adjustment

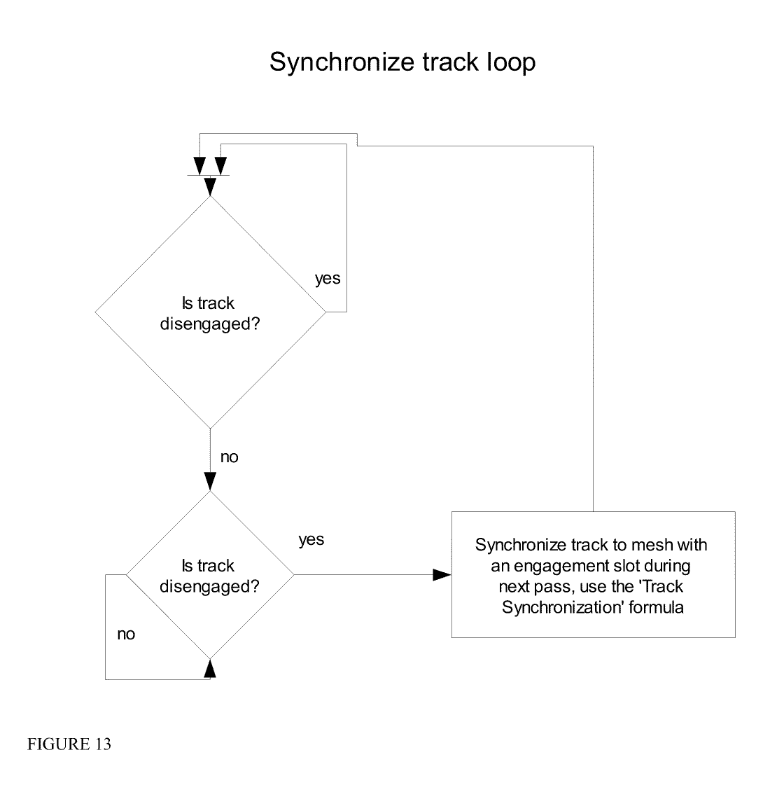

FIG. 13 is a flowchart for the track synchronization transmission computer logic

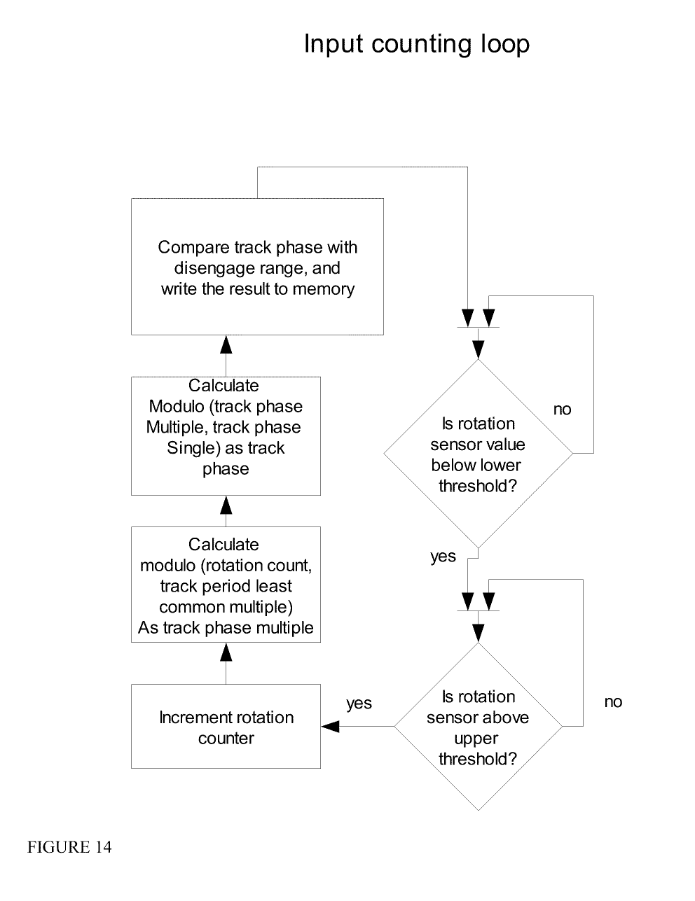

FIG. 14 is a flowchart for the input rotation counting loop transmission computer logic

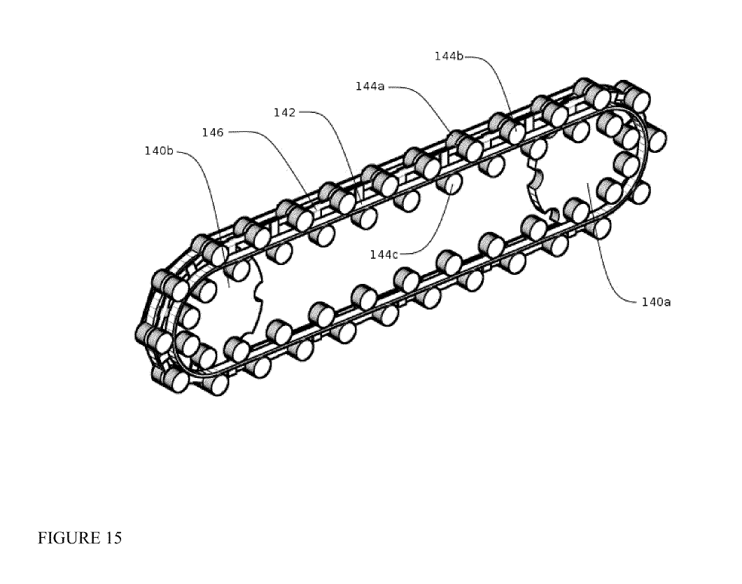

FIG. 15 is a detail of an alternate embodiment of a chain assembly

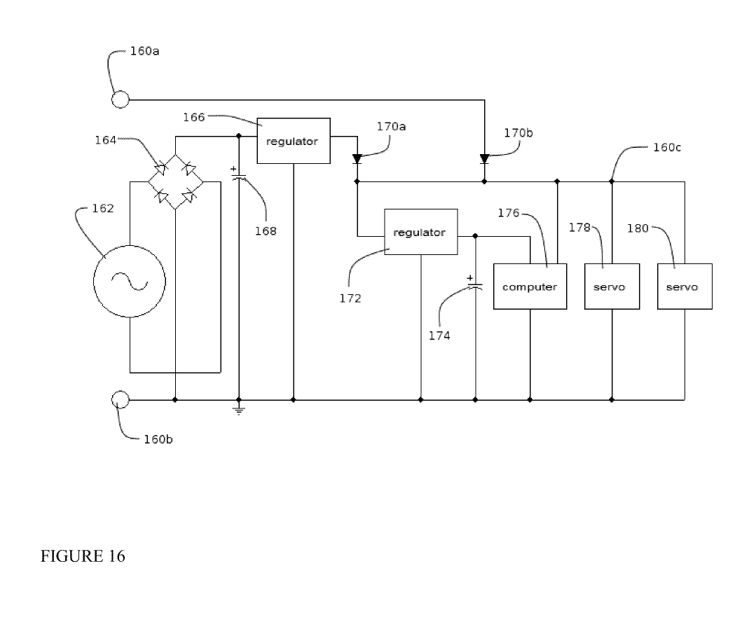

FIG. 16 is an electrical schematic for the transmission electrical power

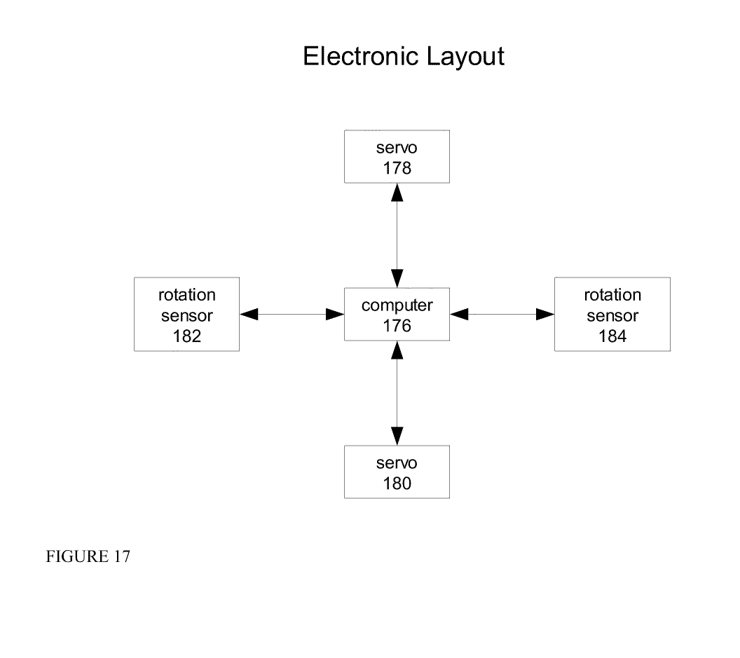

FIG. 17 is an electronic layout for the transmission components

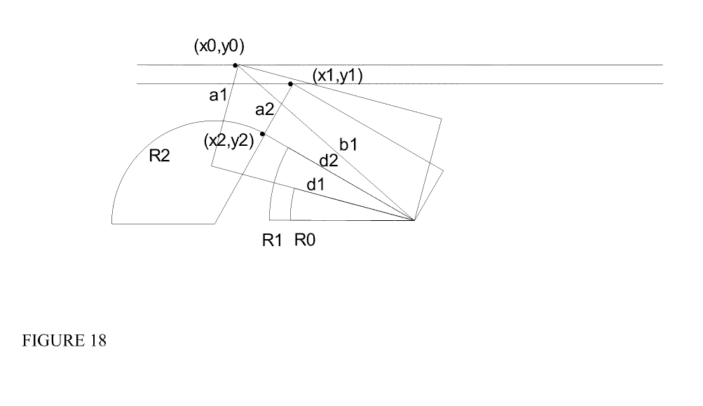

FIG. 18 is a diagram explaining track adjustments during gear ratio changes

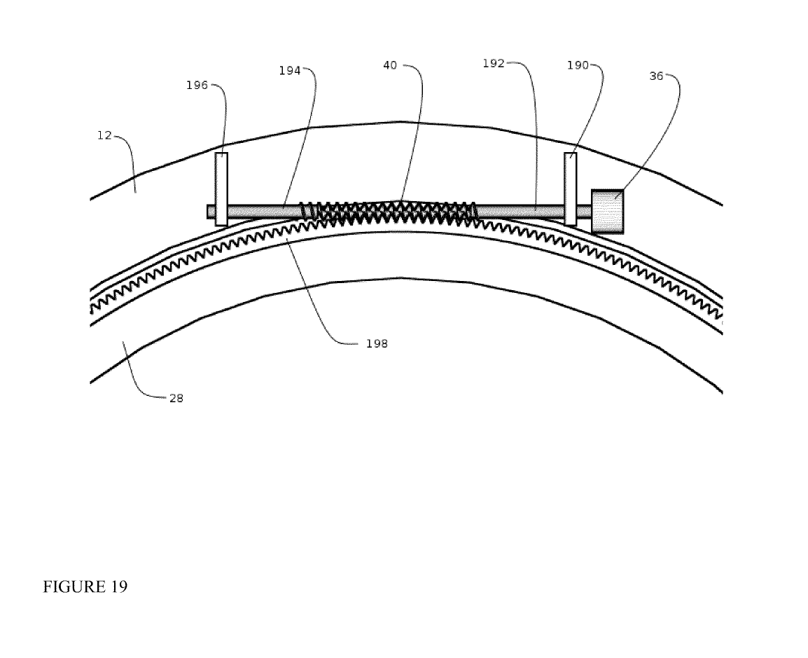

FIG. 19 is a front view showing an embodiment for gear ratio change components.

### DETAILED DESCRIPTION

Referring to the drawings, a preferred embodiment of the present invention is described. A single output assembly and a single input assembly is shown for simplicity. Another embodiment contains a plurality of input assemblies and a plurality of output assemblies. All moving parts are held rotatable or moveable with bearings to minimize friction unless stated otherwise, this includes but is not limited to: axles, worm gears, rotating rings, rotating flanges, moving guide rails and rollers in tracks.

Referring particularly to FIG. 1 and FIG. 2, an input assembly main support 14, and an output assembly outer ring 12 are both fixed to the same rigid housing. FIG. 1 shows an embodiment of the transmission, including the one output assembly and one input assembly. FIG. 2 shows an output assembly without the engagement slots to expose inner parts. The output assembly includes a plurality of engagement slots. Engagement slots 31a, 31b, and 31c in FIG. 1 are labeled and shown attached to the chain assemblies 47a and 47b. Each engagement slot is attached to the two chain assemblies 47a and 47b. One end of each engagement slot attaches to a link on chain assembly 47a, and the other end is attached to a link in chain assembly 47b. Input axle 16 is the main transmission power input, and is held rotatable in the housing. Dynamo 25 is attached to axle 16. Dynamo 25 is used to convert mechanical power from axle 16 to electrical power for operating servo assemblies at high power, and also for powering the transmission computer and rotation sensors and other electronics. Rotation sensor 24 is attached to axle 16. Rotation sensor 24 is used to measure angular speed and rotation. Its measurements are sent directly to the transmission computer for controlling the transmission. Input power to axle 16 directly drives input assembly 22. Input assembly 22's input pins, shown in FIGS. 3 and 4, slide precisely and vertically within, and power the engagement slots 31a, 31b and 31c in output assembly 30.

Inner ring 28 is held rotatable in container ring 12. Inner ring 28's rotation is set using worm gear 40. Worm gear 40 is attached to inner ring 28 and outer ring 12 through pivots attached to flanges 42a and 42b. Worm gear 40 is also attached to constant velocity joint 38, whose bend axis is in line with pivot for flange 42b. The other side of constant velocity joint 38 is attached to servo motor 36. The transmission computer directly controls servo motor 36 to set transmission gear ratios. The range of gear ratios, and the small increments of ratios between each, are dependent on precision of components. For example gear ratios in range of 2:1 (+2) forwards to park (0), and to reverse 2:1 (−2), with an increment of 1/1000 are possible with current technology. Thousands of gear ratios are possible, and even hundreds of thousands or many more are also possible with this type of transmission.

Flange 48a, flange 48b and flange 48c are rigidly connected to output assembly inner ring 28. Axle 46a is held rotatable within flange 48a and flange 48c. Axle 46b is held rotatable within flange 48b and flange 48c. Chain assembly 47a, and chain assembly 47b, rotate around axle 46a and axle 46b. Rotation sensor 62 is attached to axle 46a.

Referring particularly to FIG. 2, this embodiment shows output axle 50 is held rotatable within the transmission housing. Output axle 50 is connected to axle 46a through a system of a constant velocity joint 52, axle 54, gear 60, gear 58 and gear 56. Axle 54 is held rotatable within support member 61. Gear 60 is attached to axle 54. Gear 58 is held rotatable within support member 61. Gear 56 is attached to axle 46a. Gear 58 meshes with gear 56 and gear 60. Output axle 50 is the transmission output. Output power can be taken directly from axle 50 or directed through any rotary mechanical means. Constant velocity joint 52 has a bend axis location identical to inner ring 28's axis of rotation, allowing rotation of the output assembly to not interfere with power transmitted to axle 50.

Referring particularly to FIG. 3 and FIG. 4, this embodiment shows servo assemblies 80a, 80b, 80c, and 80d rigidly attached to support member 14, and thus stationary to the transmission housing. Track 72a is attached to the output of servo assemblies 80a and 80b. Track 72a is attached to the output of servo assemblies 80c and 80d. Pin carriers 74a and 74b ride along track 72a. Pin carriers 74c and 74d ride along track 72b. Pin carriers also slide along bars attached to chain assemblies 78a and 78b. Pin carrier 74a slides along bar set 76a. Pin carrier 74c slides on bar set 76c. Bar sets 76a, 76b, 76c, and 76d are connected to chain assemblies 78a and 78b. Using this arrangement servo motors control the horizontal position of pins for synchronization into the engagement slots, and the input axle 16 powers the pins vertically around the chain assemblies.

Referring particularly to FIG. 5, servo motor 90 is attached to counterweight 96 through worm gear 94, rigid slide bar 92a and rigid slide bar 92b. The opposite side of the servo motor from the counterweight, another mechanical load is attached, for example a pin carrier track. As servo motor 90 rotates worm gear 94, a ball screw mechanism between worm gear 94 and counterweight 96 will force counterweight 96 to move closer or further away from the servo motor in a straight line. Likewise, another ball screw mechanism between the worm gear and the mechanical load will force the mechanical load to move towards and further away from the servo motor as the worm gear rotates. The use of the counterweight is to minimize momentum forces as the servo controls the mechanical load. Rigid slide bars are used to prevent counterweights and mechanical loads from spinning and to move in a straight line only.

Referring particularly to FIG. 6, roller pin 100 is mounted to housing 102 through bearings. Roller 106 and roller 108 are mounted to housing 102 through bearings. Bar 104a and bar 104b are attached to housing 102 through bearings. The purpose of using a plurality of bars is to ensure the pin assembly moves without rotation in a straight line in the direction of bars 104a and 104b. The rollers 106 and 108 can force the pin assembly to precisely follow a track. The direction of the track in between rollers 106 and 108 and the direction of bars 104a and 104b are at 90 degree's angle. Using this arrangement, the precise 2 dimensional position of the pin assembly can be set by changing the track position (x dimension or horizontal) and by changing the bar position (y dimension or vertical).

Referring to FIGS. 7,8 and 9, various configurations of the transmission in different gear ratios are shown. FIG. 7 shows the transmission in a forward gear. FIG. 8 shows the transmission in gear 0. Gear 0 would be similar to a ‘park’ gear in some automatic transmissions, where the wheels are locked to not move, and the engine is free to rotate, while the wheels are locked from rotation. FIG. 9 shows the transmission in a reverse gear. In between the forward gear in FIG. 7, and the reverse gear in FIG. 9, an infinite number of gear ratios are possible from the forward ratio, down to 0, and past 0 to the negative gear ratios. The number of gear ratios possible is limited only to the resolution of servo motors, sensors, mechanical accuracy and computer accuracy.

Referring to FIG. 10, a chain assembly is described. The chain consists of a plurality of chain link elements, such as link element 128. A plurality of rollers rotate in each chain link element. The embodiment in FIG. 10 shows 2 rollers per chain link element, one sprocket roller 124, and one track roller 126. Sprocket rollers, such as roller 124 mesh with sprockets 120a, and 120b as the chain progresses. Track rollers, such as roller 126 roll between inner track 122b and outer track 122a. Tracks 122b and 122a are fastened rigidly to the input main support member 14 in FIG. 2. Using this arrangement of sprockets, chain links, sprocket rollers, tracks and track rollers, an axle powering a sprocket will power the chain link elements around the track in a precise, smooth and low friction manner.

As input power rotates input axle 16, the transmission computer reads the speed and position of axle 16 through rotation sensor 24. Axle 16 powers chain assemblies 78a and 78b. And thus powers pin assemblies 74a, 74b, 74c and 74d vertically around the chain assemblies 78a and 78b. The transmission computer calculates the location of all pin assemblies using the rotation sensor 24. As pin assemblies move around the chain assemblies 78a and 78b, they engage and disengage with engagement slots in the output assembly. As the pin assemblies disengage from the engagement slot, the computer calculates the horizontal position needed to synchronize for the next engagement when the pin assembly makes contact with the engagement slots again. After calculating the next horizontal position, the transmission computer controls the servo assemblies 70a, 70b, 70c and 70d to position the pin assemblies precisely.

The pin assemblies are held horizontally fixed with the servo assemblies. The pin assemblies moving vertically thus force the engagement slots horizontally, progressing the output chain assemblies 47a and 47b smoothly and continuously. A plurality of pin assemblies are required to provide constant positive engagement from input axle 16 to output axle 50 since each pin assembly powers the engagement slots only momentarily.

The range of horizontal movement for the tracks must be determined for the application. A minimum range should be first determined as being the distance between engagement slots, since this is the distance a pin assembly would need to move from one engagement slot to the next. Extra horizontal track distance range should be calculated as that needed during dynamic gear ratio change rates as described below.

Using one output assembly, it can be deduced that at minimum, 3 pin assemblies must be used to ensure constant engagement. The number of pin assemblies should be optimized for each application, for example a light duty transmission could use 3 pin assemblies, however high power transmissions or high speed transmissions would benefit from using more to provide enough torque on the output axle. Most applications would benefit from using 2 pin assemblies per track, 180 degrees apart on the track, as this would balance the momentum forces of the pin assembly's mass moving around the track. Another application, requiring higher rpm input and output axle angular speed, may benefit from using only 1 pin assembly per track, and using a counterweight on the opposite link of the track to balance momentum forces.

The speed ratio between the input pin assemblies and engagement slots is equal to the sin of the angle of the engagement slots. Since the engagement slots are ultimately connected to and have the same angle as inner ring 28, the gear ratio for the transmission from input axle 16 to output axle 50 is a factor of sin(α), where α is the angle of rotation for inner ring 28. The final gear ratio of axle 16 to axle 50 is also dependent on any other gear ratios such as gear ratios from chain links and sprocket teeth, and any connective gears such as gears 56, 58, and 60, etc.

In high torque conditions on input axle 16 and output axle 50, the transmission computer can use rotation sensor 62 to help measure the location of the output chain assemblies 47a and 47b. In another embodiment, multiple rotation sensors can be attached near the point where chain assemblies 47a and 47b attach to axles 46a and 46b.

Referring to FIG. 1 the specifications for gear ratio changing is entirely application dependent. A great variety of gear ratio changing implementations are possible. In some circumstances, the servo motors will add to the final output power of axle 50. For this reason, a careful selection of servo motor speed and power, and the mechanical advantages of attached gears and other mechanical parts is necessary. A required rate of change for gear ratios for the application should be determined across torque and rpm graphs. Using this information, the proper selection of servo motors and connected mechanical parts can then be found.

Referring to FIG. 12, an overview of the transmission computer logic for the gear changing loop is described. The transmission computer runs this loop at all times during operation. The transmission computer finds the absolute value of the difference of the desired ratio and current gear ratio with the gear ratio servo motors minimum increment. If the difference is greater, the transmission computer then calculates the new track positions required to change the gear ratio. If the tracks can be changed, then all servo motors changing gear ratios and track positions are adjusted. The speed of the adjustments would take in account any user mode applied to the transmission, such as high power or economy modes. Notice that this entire gear ratio loop runs forever along with the other loops running in the transmission computer. There is a nested loop that waits forever until the computer calculates a gear ratio servo adjustment is needed, and that the tracks can be adjusted to accommodate the new gear ratio change. If either of these conditions are not met, then the gear ratio change will not occur. A transmission designed with enough overhead for servo track horizontal range and well designed computer logic should be able to provide for tracks that can be changed as needed on a constant basis, or nearly constantly as a new gear ratio is requested.

A simple gear ratio changing transmission will be described first. The simple implementation, uses two servo controlled tracks, with 4 pin assemblies, two pin assemblies per track. The transmission computer will step a servo motor controlled track only when it is not engaged with the engagement slots. The other track's position will be held constant. Since a speed increase on the output axle will occur during a change to a higher gear ratio occurs, the servo motor controlling inner ring 28's position will be required to add its own power minutely to the output axle 50, depending on the actual gear ratios of the servo motor, worm gear, etc. In this simple implementation, the gear ratio rate of change will not be constant, as actual changing will only occur while one input track is not engaged. While both tracks are momentarily engaged with the engagement slot, the gear ratio changing must pause until only one pin assembly is engaged with the engagement slot. When one pin moves beyond the engagement slot's range, the transmission computer can resume gear changing. And also at this time, the track that is not engaged can be adjusted for the next pass in the engagement slots. A simple model for the new position for a disengaged track can be calculated as the ‘Track Synchronization’ formula:

servo position=Modulo((f*sin(α)+(other servo position)),track horizontal range)

Where constant factor ‘f’ is dependent on the geometry of an application. In fact this relatively simple formula serves as the basis for all transmissions regardless of the particular implementation. It may be required to add other factors, and adjust original factors to accommodate gear ratio rate of change. The term ‘other servo position’ will have to be determined when more than two pin assembly tracks are present in the transmission. With more than two tracks are present in the system, the tracks may be viewed as elements along a circle, where each track has a neighbor to its left and right. Each track would use the track on its left as the previous track. Anticipation may be necessary as to the track position required for the future gear ratio of the transmission when the track becomes engaged.

Referring to FIG. 13, the track synchronization flowchart loop is described. The transmission computer will run one of these loops for each track present in the transmission. The entire loop uses two smaller loops that wait until the track is engaged, and then disengaged. The reason for this is to program an edge activation, where a track synchronizes, or adjusts for the next engagement slot in one quick move immediately after the track is disengaged. This is to provide more control over the system, to quickly synchronize the track as soon as possible to provide for higher input and output axle rpms. Also, the computer will not try to adjust a track for synchronization many times while the track is disengaged, as only one synchronization is required during each revolution of the track.

Now a more complex gear ratio changing will be described. A transmission with the capability of changing gear ratios without interruption requires that all computer controlled servo motors are adjusted simultaneously during the gear ratio change. As servo motor 36 changes the rotation of inner ring 28 and all attached components, all servo assemblies controlling track positions must be adjusted simultaneously to precisely fit all pins in the engagement slots. These requirements would be in addition to the simple gear ratio changing position described earlier. This more complex transmission with constant gear ratio change means the track servo assemblies now must meet higher power and speed requirements, as a factor of the gear ratio rate of change multiplied by the transmission power. Also since all tracks must be changed simultaneously, a new real time anticipation of all track positions, ranges, and predicted gear ratios must be calculated to provide the most uninterrupted gear ratio change possible. A transmission's control algorithms can become very complex as real time control of more dynamic parts is needed.

Referring to FIG. 14, the input rotation counting loop is described. One loop per track can be used. All the loop elements are redundant, except the two elements: “Compare track phase with disengage range, and write the result to memory as boolean ‘disengaged’”, and “Calculate modulo (track phase multiple, track phase single) as track phase”. Using one loop can be used for all tracks, and duplicating the two non redundant elements once for each track. Most any type of rotation sensor can be used with this transmission, as long as it can respond quickly and accurately enough with a useful rotation value. The diagram describes a rotation sensor that responds with analog values when the transmission computer requests a reading. The values for this sensor will range from a low number to a high number, many times per revolution of an axle it is attached to, in this case axle 16. The entire loop waits until the rotation sensor value is below a lower threshold, then waits until it is over an upper threshold value. Using these two inner loops, the computer can run an edge activated block of code, once per time as the rotation sensor value moves from low to high. On the rising sensor value edge, the computer increments the rotation counter. Using the counter value, a modulo of this counter is calculated, as the track phase multiple. It is crucial that this modulo results in an exact integer number of rotations for a track. The reason for this is that any approximation, however slight, will eventually result in the transmission computer losing the track phase over time. To avoid losing position information, therefor the track period least common multiple must be the smallest number that would result in no creeping errors resulting from an approximation. This can be determined by finding the least number of exact integer rotations of the input axle 16 that will result in an exact number of rotations of the tracks. This can also be verified by calculating all the gear ratios from input axle 16 all the way to and including the tracks, including the gear ratio of chain assemblies using the number of chain links and teeth on sprockets.

There are many variations of the preceding description to accommodate different requirements. The variations typically encompass changing a few components, or changing the number of components to balance different amounts of economy, torque, speed and power.

Referring to FIG. 11, an embodiment comprising input assemblies with 4 servo assemblies per track, versus 2 per track is possible to accommodate high torque. Four servo assemblies 70e, 70f, 70g and 70h are arranged in a rectangle, placed as far apart as possible on the track to ensure the track will not rotate or bend as the pin forces the engagement slot to move. Using four servo assemblies should minimize rotations in all 3 dimensions, controlling the track 72a's only degree of freedom, horizontal movement.

Another embodiment possible where instead of 2 pin assemblies per track, a single pin assembly and a counterweight at the opposite side are used. The purpose of using a single pin assembly would be to accommodate higher rpms for input axle 16 and output axle 50, while using the same speed servo assemblies 80a, 80b, 80c and 80d. Higher speed servo assemblies can also accommodate higher transmission rpms with axles 16 and 50.

Referring to FIG. 15, another embodiment for track assemblies is possible. Only one track 142 is used in this embodiment. A plurality of rollers, such as 144a, mesh with sprockets 140a and 140b. A plurality of rollers such as 144b rolls along the outside of track 142. A plurality of rollers such as 144c rolls on the inside of track 142. Using three rollers per chain link will further reduce friction and increase accuracy of the chain link movement. A plurality of chain links such as 146 have a ‘T’ shaped half where inner rollers such as 144c are attached. Viewing FIG. 15, a triangular pattern of rollers can be seen, where inner rollers are between the two outer rollers on each chain link. This triangular arrangement is very stable, and prevents unwanted movements of each link, keeping each link in a very straight line between each sprocket, providing for highly accurate motion required for the transmission. This embodiment will slightly increase the complexity and size of the transmission, but will improve the lifespan, efficiency, and accuracy of the transmission. The arrangement of rollers on each link will determine the shape of the tracks. The tracks must be made to fit the motion of the chain links, which are straight lines between sprockets, and circular around the sprockets. The inner and out edges of the tracks would not only differ in size but also in shape to guide the links with rollers in the motion described.

Referring to FIG. 16, an electrical schematic for power distribution is described. Electric node 160b represents an external ground, such as a vehicle ground. Node 160a represents an external voltage source, such as a vehicle positive power connection. Dynamo 162 is attached to input axle 16. Rectifier bridge 164 rectifies dynamo 162's output. Capacitor 168 and regulator 166 provide a regulated dc voltage from rectifier 164. Diode 170a provides power from regulator 166 to node 160c. Regulator 172 and capacitor 174 provide for delivery of highly regulated power to the transmission computer. Diode 170b provides power to node 160c from node 160a. Diodes 170a and 170b both provide power to 160c but at different times. The transmission computer can read voltage of node 160c to determine if powering a plurality of servo motors should be paused if necessary voltage levels are not present, as further current draw from servo motors may reduce node 160c to undesired levels. During initialization, such as a driver turning on a vehicle, battery power is ultimately used to pull diode 170b voltage high, and subsequently power node 160c, the plurality of servos, the transmission computer, and regulator 172. During initialization, the transmission computer checks that the transmission is in an idle state, such as gear ratio zero, or ‘park’ to prevent the vehicle lurching forward accidentally. If the transmission is not in gear zero, or some predetermined start gear, the computer will adjust all servos to set the gear ratio. The transmission computer will relay this information to an external computer, such as a main vehicle computer, that the gear ratio is correct, and that starting a vehicle main engine is now safe. As input axle 16 rotates from an external source, such as a vehicle engine, electric power transmission to diode 170a provides more voltage that the voltage from diode 170b, effectively reducing current through diode 170b to zero. Using this setup described, as external power source, such as a vehicle main engine, rotates input axle 16, the dynamo 162 takes over providing power to the servos and transmission computer, instead of an external source such as a vehicle battery. Electrical power generation from mechanical power of axle 16 can become necessary to provide more power to servo motors if needed. As servos are required to briefly and at high mechanical advantage power the vehicle, a great drain on an external power source, such as a vehicles main electrical system, could result in unwanted effects, such as a vehicle power electric system losing regulated power to other vehicle systems such as the main vehicle computer, ignition systems, environment comfort systems, etc. The size and power rating of dynamo 162 is dependent on application. A very high performance system where very fast gear ratio changes are required, may require a higher power dynamo and related components such as regulators and diodes.

Another embodiment without dynamo 162 is possible. A low power, or economy system, or system requiring low gear ratio change speeds, may not need to convert mechanical power from axle 16 to electrical power. If careful design shows that external power, such as vehicle provided electric power is sufficient to provide peak power to servo motors and the transmission computer, then dynamo 162, rectifier 164, regulator 166, diode 170a, and capacitor 168 are not required.

Referring particularly to FIG. 17, the electronic data layout of the transmission computer is described. Transmission computer 176 sends and receives data to and from a plurality of servos such as 178 and 180, and a plurality of rotation sensors such as 184 and 182.

Referring particularly to FIG. 18, the adjustments for track horizontal positions during gear ratio changes is explained. Changing gear ratios with pins engaged requires great precision, servo motors and attached components must be capable of changing positions within a required tolerance, with required torque and speed as well. The formulas shown calculate the new pin position at time Δt, or after a certain time period. The formulas assume the servo motors and the main mechanical power input (a vehicles main motor for example) are powerful enough to change positions of transmission components within Δt. The transmission computer must be aware of the power limitations of all motors to find gear ratio speed change maximum values. If:

constant acceleration=a
input axle 16 angular speed=r
distance (of vehicle, proportional to output assembly distance, or angular rotation of output axle)=d
time span=Δt

using distance formula: d=0.5*a*Δt*Δtv*Δt

(x0,y0)=current pin position, x0=track horizontal position, y0=pin vertical position along track
Angle R0=current gear ratio
(x1,y1)=pin position at new time delta t, y1=y0+Δt*c*r
Where c is a constant depending on internal gear ratios of input axle to track, including
Sprocket Teeth and number of chain links and any other gear ratios in between
Angle R1=new gear ratio, R1=R0+gear ratio rate of change*Δt
X1 can be found as:

Angle P0=a tan(x0/y0)

Use law of sines to find lengths for green rectangle

Angle P1=a tan(x1,y1)=current gear ratio

Angle A1=angle P0−angle R0

Angle D1=180−90−A1=90−A1

b1=sqrt(x0*x0+y0*y0)

d1/sin(D1)=b1/sin(90)=b1=a1/sin(A1),d1=sin(D1)*b1

d2=d1+v*Δt+0.5*aΔt*Δt

(x2,y2)=(d2,0) rotated by R1=(d2*cos(R1),d2*sin(R1)

R2=R1+90

Slope M2=tan R2=tan(R1+90)

Using point slope formula: y−y2=M2*(x−x2)
Finding the intercept of line yields x1:

y1−y2=M2*(x1−x2),x1−x2=(y1−y2)/M2,x1=x2+(y1−y2)/M2

x1=d2*cos(R1)+(y1−d2*sin(R1)/tan(R1+90)

The new vertical pin position at Δt is: y1=y0+(Δt)*c*input axle speed. The new pin horizontal position is deduced as: x1=d2*cos(R1)+(y1−d2*sin(R1)/tan(R1+90).

The transmission computer must calculate if x1 falls out of horizontal range for the track before changing gears for all tracks. If any out of range condition exists for any track, then gear ratio change must pause until tracks can be adjusted. Δt should be as close to 0 as possible, limitation to Δt being smaller being speed of the transmission computer, servo motor limitations, and precision of mechanical parts.

Referring particularly to FIG. 19, another embodiment replacing the gear ratio controlling mechanical components flange 42a, constant velocity joint 38, flange 42b is possible. Worm gear 40 is attached to axle 194 on one end, and axle 192 on the other end. Axle 194 is held rotatable within flange 196. Axle 192 is held rotatable within flange 190. Servo motor 36 is attached recessed in outer ring 12. Servo motor 36 is attached to axle 192 and controls rotations of axle 192, worm gear 40 and axle 194. A large ring gear 198 is rigidly attached to inner ring 28. Gear 198 meshes with worm gear 40. Using this setup, servo motor 36 controls the rotation of inner ring 28 against outer ring 12, and thus controls the gear ratio of the transmission. The large amount of friction of worm gear 40 meshing with gear 198 will cause the gear ratio to lock, that is any rotational force of inner ring 28 will not cause worm gear 40 to rotate. Also due to this high amount of friction, servo motor 36 must work extra to overcome the added friction. The friction may be so great in large torque applications, that this embodiment would be impractical, and gear ratio change rates would be very low. Also, the high amount of friction would cause accelerated wear on worm gear 40 and gear 198, such that regular maintenance of replacing or re machining would be required for worm gear 40 and gear 198. Using the original embodiment may be required instead. However, this embodiment is particularly sturdy, more precise, and has fewer components. Therefor, a very powerful gear ratio changing servo motor may be required to use this embodiment.

Another embodiment replacing all electrical components including the transmission electronic computer, rotation sensors and servo motors is possible. Mechanical components to replace the computer, servo motors and sensors are possible. The necessary mechanical components are not shown and would amount to a great increase in overall complexity. An all mechanical embodiment of the transmission would not be preferred or practical in a general application. Electronic calculations and sensors would be much more efficient, more reliable, considerably less massive and have longer life than a mechanical version. However an all mechanical version may be useful as a demonstration model or where electronics would be better replaced with mechanical parts due to environment or other factors.

Another embodiment using a different number of simultaneous loops is also possible. A transmission computer can run all loops as one much larger loop instead, or any number of loops required to perform the necessary logic and calculations. The programming logic using several simultaneous loops described in FIGS. 12, 13 and 14 are very simple, and programming them would be straightforward. Production, engineering, and modifications to the several loop approach would be simple and easy to modify. Actual performance of multiple loops would be robust and tolerant to introduction to errors in design. However, any number of loops, including just one loop, can also be used, as multiple loops are not required.

I claim:

1. An infinitely variable positively engaged mechanical transmission for converting an input rotary mechanical power to an output rotary mechanical power comprising:
a drive element serving as a means for power input;
a driven element serving as a means for power output;
a plurality of displace able elements serving as a path that can move back and forth;
a mechanical means where said drive element is connected to said plurality of displace able elements serving as a path;
one or more elements moving along a said displace able path element;
a means where said drive element advances a said element along a said displace able path;
a means to control the position of said displace able path element;
an element serving as a path that can be rotated;
a means of controlling the rotation of said rotatable path element;
a plurality of elements that move along said rotatable path element;
a means where an element moving along said displace able path element pushes a said element moving along said rotatable path element;
a mechanical means where said element serving as a path that can be rotated is connected to said driven element;

2. An infinitely variable positively engaged mechanical transmission of claim 1 wherein said drive element is an axle.

3. An infinitely variable positively engaged mechanical transmission of claim 1 wherein said driven element is an axle.

4. An infinitely variable positively engaged mechanical transmission of claim 1 wherein said displace able elements serving as a path are one or more chain and sprockets sets.

5. An infinitely variable positively engaged mechanical transmission of claim 4 wherein said chain elements have rollers attached that roll along a track to cause said chain elements to be restricted to movements along said track's path.

6. An infinitely variable positively engaged mechanical transmission of claim 1 wherein said means to control said position of said displace able path is one or more servo motors which are controlled by an electronic computer that is also connected to a rotation sensor attached to said drive element.

7. An infinitely variable positively engaged mechanical transmission of claim 1 wherein said element serving as a path that can be rotated is one or more chain and sprockets sets connected to an inner ring that can rotate inside an outer ring.

8. An infinitely variable positively engaged mechanical transmission of claim 7 wherein said chain elements have rollers attached that roll along a track to cause said chain elements to be restricted to movements along said track's path.

9. An infinitely variable positively engaged mechanical transmission of claim 1 wherein said means of controlling said rotation of said rotatable path element is a worm gear meshing with gear teeth connected to said inner ring that is controlled by a servo motor that is controlled by an electronic computer.

10. An infinitely variable positively engaged mechanical transmission of claim 1 wherein said means of controlling said rotation of said rotatable path element is a constant velocity joint controlled by a servo motor that is controlled by an electronic computer, a rotatable flange attached to said inner ring, a rotatable flange attached to said housing, a worm gear attached to the other end of said universal joint and meshing with said flange attached to said inner ring.

11. An infinitely variable positively engaged mechanical transmission of claim 1 wherein said one or more elements moving along a said displace able path element is a roller.

12. An infinitely variable positively engaged mechanical transmission of claim 1 wherein said plurality of elements that move along said rotatable path element is an engagement slot.

13. An infinitely variable positively engaged mechanical transmission of claim 1 wherein said means where an element moving along said displace able path element pushes a said element moving along said rotatable path element is a roller rolling in and pushing an engagement slot.

14. An infinitely variable positively engaged mechanical transmission of claim 1 wherein said displace able elements serving as a path is one or more belt and pulley sets.

15. An infinitely variable positively engaged mechanical transmission of claim 1 wherein said element serving as a path that can be rotated is one or more belt and pulley sets.

16. An infinitely variable positively engaged mechanical transmission of claim 1 wherein said means to control said position of said displace able path is a mechanical means comprising mechanical computations and mechanical actuators.

17. An infinitely variable positively engaged mechanical transmission of claim 1 wherein said means of controlling said rotation of said rotatable path element is a worm gear meshing with gear teeth connected to said inner ring that is controlled by a mechanical means comprising mechanical computations and mechanical actuators.

18. An infinitely variable positively engaged mechanical transmission of claim 1 wherein said means of controlling said rotation of said rotatable path element is a constant velocity joint controlled by a mechanical means comprising mechanical computations and mechanical actuators, a rotatable flange attached to said inner ring, a rotatable flange attached to said housing, a worm gear attached to the other end of said universal joint and meshing with said flange attached to said inner ring.

19. An infinitely variable positively engaged mechanical transmission of claim 1 wherein said means where said element moving along said rotatable path powers said driven element consists of a constant velocity joint attached to said driven element and a plurality of gears powered by said element serving as a path that can be rotated.
